(19) United States
(12) Patent Application Publication
(10) Pub. No.: US 2016/0004441 A1
(43) Pub. Date: Jan. 7, 2016

(54) ACCESS CONTROL METHOD FOR ACCESSING DATA IN STORAGE AND DISK DRIVE

(71) Applicant: FUJITSU LIMITED, Kawasaki-shi (JP)

(72) Inventors: Hidekazu TAKAHASHI, Kawasaki (JP); Miho MURATA, Kawasaki (JP); Yuichi TSUCHIMOTO, Kawasaki (JP); Kazutaka OGIHARA, Hachioji (JP); Motoyuki KAWABA, Kawasaki (JP)

(21) Appl. No.: 14/857,085

(22) Filed: Sep. 17, 2015

Related U.S. Application Data
(63) Continuation of application No. PCT/JP2013/058428, filed on Mar. 22, 2013.

(51) Int. Cl. G06F 3/06

(52) U.S. Cl. CPC G06F 3/061; G06F 3/0659; G06F 3/0652; G06F 3/064; G06F 3/0673

(57) ABSTRACT

An access control method includes: in response to a first access instruction that instructs accessing first data, reading the first data and second data from a storage and deleting the first data and the second data from the storage, the first data being read from a first storage area, the second data being read from a second storage area that is physically adjacent to the first storage area and is not an empty area; and in response to a second access instruction that instructs writing third data to the storage, writing the third data to a third storage area that is adjacent to a storage area located in a physically rearmost position among storage areas in which data has been stored in the storage.

### CROSS-REFERENCE TO RELATED APPLICATION

This application is a continuation application of International Application PCT/JP2013/058428 filed on Mar. 22, 2013 and designated the U.S., the entire contents of which are incorporated herein by reference.

### FIELD

The embodiments discussed herein are related to a technology for accessing data stored in a storage.

### BACKGROUND

In recent years, with the speeding-up of business, there is a need for real-time processing on a large amount of data that consecutively flows. Accordingly, stream data processing is attracting attention.

Stream data processing is performed, for example, by a server computer. In the stream data processing, when flowing data is written to a memory included in the server computer, analytical processing is performed on the data in real time.

In the stream data processing, when a large amount of data flows, a storage area that stores data to be analyzed is sometimes deficient in the memory included in the server computer. Then, the server computer performs processing of writing data that has least recently been used among data stored in the memory to a disk in the server computer. The server computer secures a cache area for storing data to be used for analytical processing in the memory by deleting the data that has been written to the disk from the memory. When the server computer uses the data that has previously been written to the disk in analytical processing, the server computer reads the data that has been written to the disk to the memory, and performs analytical processing.

In the above stream data processing, as an example, when an amount of flowing data increases, a large number of access instructions to write or read data to a disk are processed. Accordingly, in the stream data processing, it takes a lot of time to perform access processing such as writing or reading of data to of from a disk. This causes a reduction in throughput in analytical processing. Thus, in the stream data processing, in order to improve throughput in analytical processing, it is preferable to reduce the number of accesses to data on a disk.

In view of the foregoing, in the stream data processing, as an example, a server computer associates pieces of data stored in a disk respectively with keys that identify the respective pieces of data, and performs mapping so as to arrange the respective pieces of data in a specified order, by using a logical configuration such as a B-tree. In accordance with the mapping result, the server computer arranges and stores the respective pieces of data in the specified order in storage areas of the disk. When the server computer reads plural pieces of data from the disk, the server computer reads the plural pieces of data from the disk in a single access by specifying a range of keys. As a result, in the stream processing, the server computer can reduce the number of accesses to the disk.

Note that Japanese Laid-open Patent Publication No. 2005-322215 describes related art.

In the access control technology described above, pieces of data are arranged and stored in physically continuous storage areas in accordance with the order of keys. Therefore, in order to maintain data arrangement, when additional data or data that has increased in data size as a result of updating is written to a disk, a server computer performs processing of rearranging other pieces of data such that a storage area for the data to be written is secured in a specified position. Accordingly, it takes time to perform processing of rearranging the other pieces of data, and this causes a reduction in throughput in access processing.

In addition, in the access control technology described above, in reading plural pieces of data, when respective pieces of data to be read have not been arranged so as to be physically consecutive, random access is performed to storage areas in which the respective pieces of data have been stored so as to read the respective pieces of data. Therefore, the number of times of seeking process for moving a header so as to read the respective pieces of data from the disk increases, and this causes a reduction in throughput in access processing.

Further, in the access control technology described above, when data is written, processing of reading data stored in a storage area that is a writing destination is performed so as to check whether data exists. When data exists, the server computer determines that data to be written is updating data, and when data does not exist, the server computer determines that data to be written is additional data. Therefore, even when data is written, reading processing is performed, and this causes a reduction in throughput in access processing. The server computer may be configured to refer to management information that manages the existence of respective pieces of data in order to eliminate reading processing in writing data. However, in this case, management information for a large amount of data is stored, and therefore a memory is consumed.

As described above, the access control technology described above has a problem wherein a physical arrangement of data and access scheme are inefficient and thus a throughput of an access processing is reduced.

### SUMMARY

According to an aspect of the invention, a non-transitory computer-readable recording medium having stored therein an access control program that causes a computer to execute a process includes: in response to a first access instruction that instructs accessing first data, reading the first data and second data from a storage and deleting the first data and the second data from the storage, the first data being read from a first storage area, the second data being read from a second storage area that is physically adjacent to the first storage area and is not an empty area; and in response to a second access instruction that instructs writing third data to the storage, writing the third data to a third storage area that is adjacent to a storage area located in a physically rearmost position among storage areas in which data has been stored in the storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of a disk drive.

FIG. 2 illustrates an example of a stream data processing system.

FIG. 3 illustrates exemplary data of a message.

FIG. 4 is a functional block diagram illustrating an example of a server.

FIGS. 5-8 are sequence diagrams illustrating stream data processing.

FIG. 9 illustrates exemplary data of a segment management table.

FIG. 10 illustrates exemplary data of an address management table.

FIGS. 11-12 are flowcharts illustrating processing of determining the number of segments.

FIG. 13 is a flowchart illustrating processing of reading segments.

FIGS. 14-16 illustrate examples of a storage state of segments in a low-speed storage medium.

FIG. 17 is a flowchart illustrating processing of writing segments to a high-speed storage medium.

FIG. 18 is a flowchart illustrating processing of writing segments to a low-speed storage medium.

FIGS. 19-20 illustrate examples of a storage state of segments in a low-speed storage medium.

FIG. 21 is a block diagram illustrating an example of a computer device.

### DESCRIPTION OF EMBODIMENTS

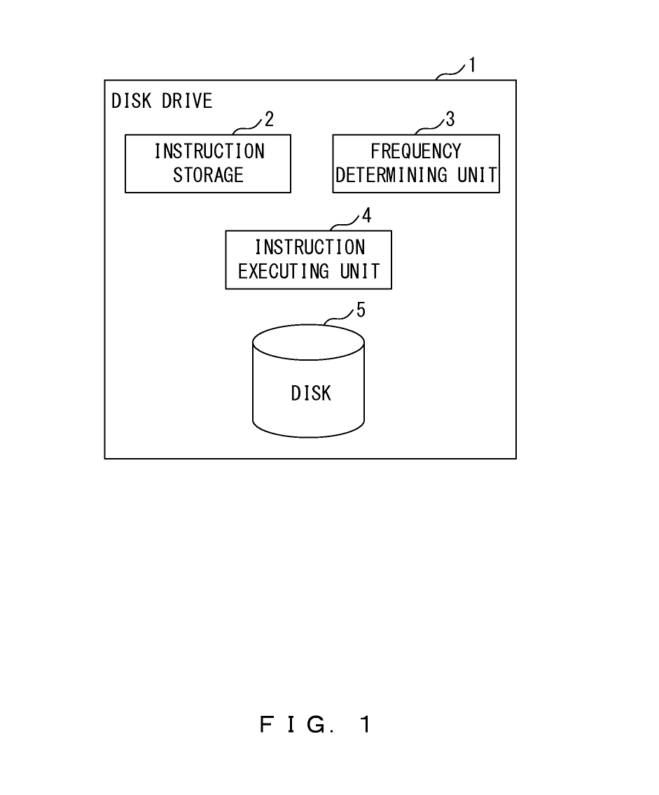

FIG. 1 is a functional block diagram illustrating an example of a disk drive. With reference to FIG. 1, a disk drive is described.

A disk drive 1 includes an instruction storage 2, a frequency determining unit 3, an instruction executing unit 4, and a disk 5. The disk drive 1 is, for example, computer equipment such as a server 30 described later.

The instruction storage 2 stores an access instruction that requests to read data that has been received by the disk drive 1 and has been stored in the disk 5, or that requests to write data to the disk 5. The instruction storage 2 corresponds, for example, to an instruction storage 62 described later.

In processing of reading data groups from the disk 5, when the number of access instructions stored by the instruction storage 2 increases, the frequency determining unit 3 increases the number of data groups to be read at a time. On the other hand, when the number of access instructions stored by the instruction storage 2 decreases, the frequency determining unit 3 decreases the number of data groups to be read at a time.

When the number of access instructions stored by the instruction storage 2 is greater than or equal to a specified threshold, the frequency determining unit 3 may multiply the number of data groups to be read at a time by K (K>1). When the number of access instructions stored by the instruction storage 2 is less than a specified threshold, the frequency determining unit 3 may multiply the number of data groups to be read at a time by L (L<1). The frequency determining unit 3 corresponds, for example, to a determining unit 63 described later. Note that K and L may satisfy, for example, K=1/L. The frequency determining unit 3 may set an integer value obtained by multiplying the number of data groups to be read at a time by K or L and rounding down a fraction of the multiplied value so as to be the number of data groups to be read at a time. The frequency determining unit 3 may perform processing of increasing or decreasing n data groups every time processing of reading data groups is performed.

The instruction executing unit 4 receives the third access instruction that accesses to the first data group that includes one or more pieces of data stored in a storage. In reply to the third access instruction, the instruction executing unit 4 reads n data groups (n is a natural number) that respectively include one or more pieces of data from n storage areas that are physically continuous, including the first storage area in which the first data group has been stored. The instruction executing unit 4 then deletes the n read data groups. The instruction executing unit 4 corresponds, for example, to an instruction executing unit 61 described later. The storage corresponds, for example, to the disk 5 or a low-speed storage medium 70 described later.

The instruction executing unit 4 receives the fourth access instruction to write m data groups (m is a natural number) that respectively include one or more pieces of data to the storage, and the m data groups. In reply to the fourth access instruction, the instruction executing unit 4 writes the m data groups respectively to empty areas form data groups that are physically continuous behind a storage area located in a physically rearmost position (or edge) among storage areas that are included in the storage and to which a plurality of data groups respectively including one or more pieces of data have been written.

In processing of reading data groups, when an empty area exists in the n storage areas, the instruction executing unit 4 reads one or more data groups, instead of the n data groups, from physically continuous storage areas in which data groups have been stored, including the first storage area, among the n storage areas. The instruction executing unit 4 also deletes the one or more read data groups.

Upon receipt of a plurality of access instructions that consecutively flow, the instruction executing unit 4 stores the received access instructions in the instruction storage 2.

The disk 5 corresponds, for example, to a low-speed storage medium 70 described later.

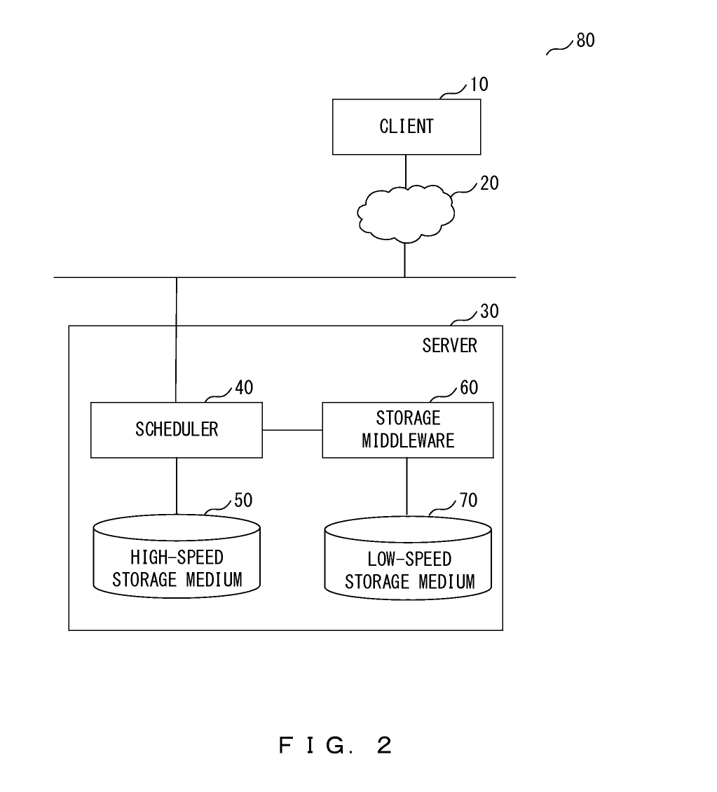

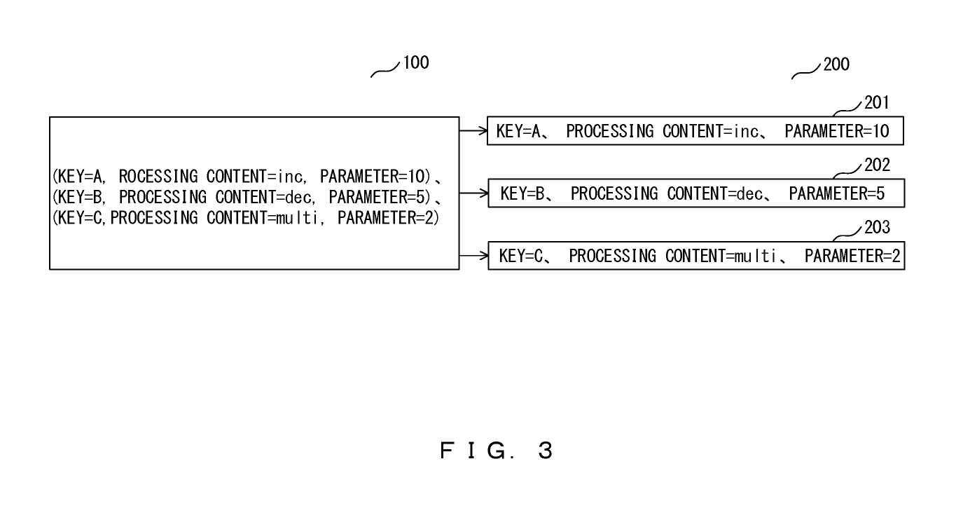

FIG. 2 illustrates an example of a stream data processing system. FIG. 3 illustrates exemplary data of a message.

As illustrated in FIG. 2, a stream data processing system 80 includes a client 10, a network 20, and a server 30.

The client 10 is, for example, computer equipment described later, and is connected to the server 30 via the network 20. The client 10 transmits, to the server 30, a message 100 that includes keys, pieces of processing content, and parameters illustrated in FIG. 3, for example. By so doing, the client 10 requests that the server 30 perform analytical processing. The message 100 includes keys, pieces of processing content, and parameters relating to three processes, but the message 100 is not limited to this, and different messages may be used for respective processes.

The message 100 includes, for example, a key that identifies specified data, content of processing performed on the specified data, and a parameter used for the processing. The message 100 is a request message that is transmitted from the client 10 to the server 30 when data that corresponds to a specified key is read and the server 30 is made to perform specified processing on a parameter included in the data.

“key=A, processing content=inc, parameter=10” in the first line of the message 100 indicates a request for the server 30 to add (“processing content=inc”) “parameter=10” to a parameter of data that corresponds to “key=A”. “key=B, processing content=dec, parameter=5” in the second line of the message 100 indicates a request for the server 30 to subtract (“processing content=dec”) “parameter=5” from a parameter of data that corresponds to “key=B”. “key=C, processing content=multi, parameter=2” in the third line of the message 100 indicates a request for the server 30 to multiply (“processing content=multi”) a parameter of data that corresponds to “key=C” by “parameter=2”. Note that the message 100 is not limited to the example described above, and may be any message that indicates the content of processing requested by the client 10 and that includes information for causing the server 30 to perform the processing.

The network 20 provides a communication path between the client 10 and the server 30. Examples of the network 20 include LAN (Local Area Network), wireless communication network, the internet, and the like.

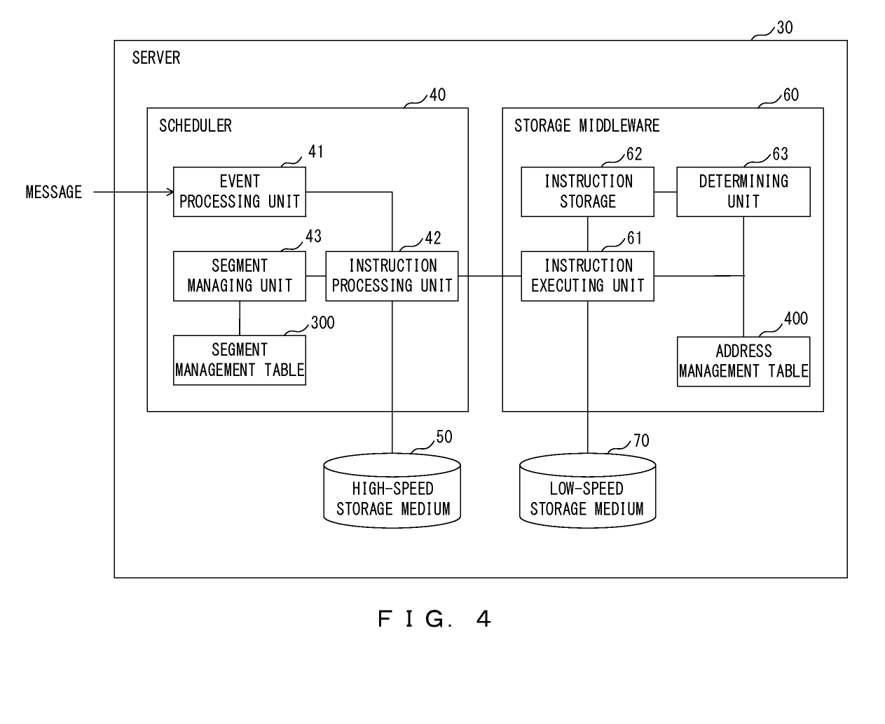

FIG. 4 is a functional block diagram illustrating an example of a server. The server 30 includes a scheduler 40, a high-speed storage medium 50, storage middleware 60 (an access control program), and a low-speed storage medium 70.

The scheduler 40 has functions of an event processing unit 41, an instruction processing unit 42, and a segment managing unit 43, as illustrated in FIG. 4. The scheduler 40 also includes a segment management table 300. The segment management table 300 may be stored in the low-speed storage medium 70 and may be used in access processing by being loaded to the high-speed storage medium 50 at the time of starting the scheduler 40.

The storage middleware 60 has functions of an instruction executing unit 61, an instruction storage 62, and a determining unit 63, as illustrated in FIG. 4. The storage middleware 60 also includes an address management table 400. The address management table 400 may be stored in the low-speed storage medium 70 and may be used in access processing by being loaded to the high-speed storage medium 50 at the time of starting the storage middleware 60.

The high-speed storage medium 50 is a small-capacity high-speed storage medium. The high-speed storage medium 50 is a memory such as a RAM (Random Access Memory).

The low-speed storage medium 70 is a large-capacity low-speed storage medium. The low-speed storage medium 70 sections a storage area into a plurality of areas having a fixed size, and stores one or more pieces of data in respective sections. The section having a fixed size in the storage area of the low-speed storage medium 70 maybe referred to as a “block”. A data group including one or more pieces of data stored in the same block may be referred to as a “segment” The one or more pieces of data included in the segment may be associated with each other such that analytical processing is performed efficiently by the instruction processing unit 42. The low-speed storage medium 70 is, for example, a hard disk.

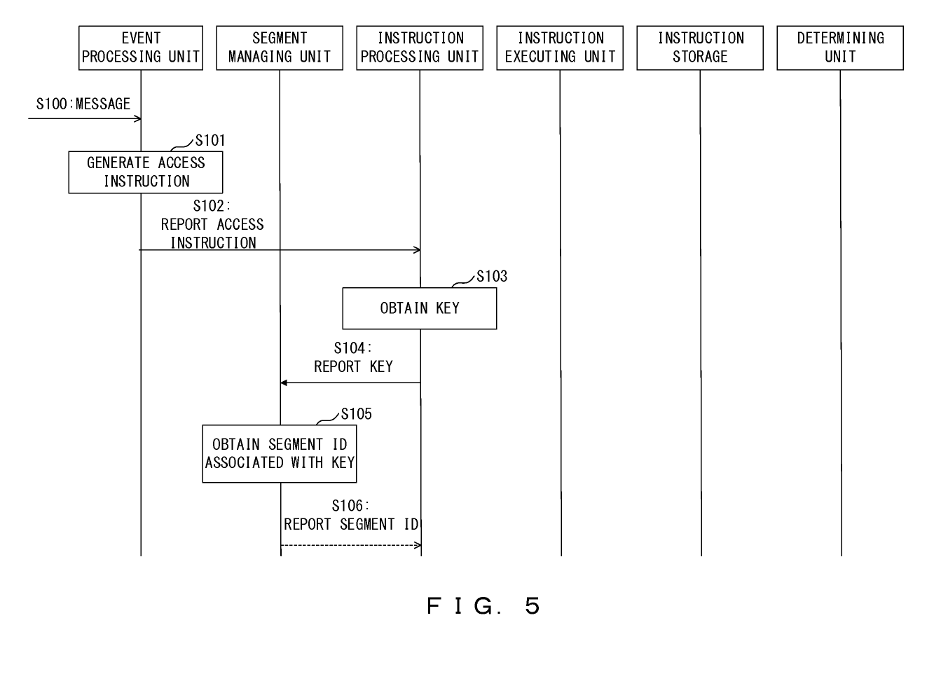

With reference to FIGS. 5-8, details of processing performed by respective functions of the server 30 are described. The following description is given, as an example, under the assumption that the server 30 has received the message 100.

The event processing unit 41 obtains the message 100 that the server 30 has received from the client 10 (S100). The event processing unit 41 generates an access instruction 200 by using the obtained message 100 (S101).

The access instruction 200 is information for reporting a request for analytical processing included in the message 100 to the instruction processing unit 42. Upon receipt of the message 100 illustrated in FIG. 3, for example, the event processing unit 41 extracts keys, pieces of processing content, and parameters from the message 100. The event processing unit 41 then associates corresponding processing content with a parameter used for the processing for each of the extracted keys to generate the access instruction 200.

When the event processing unit 41 obtains the message 100 illustrated in FIG. 3, for example, the event processing unit 41 generates access instructions 201-203 that respectively correspond to keys A-C. The access instruction 201 is information for reporting a request described in the first line of the message 100 to the instruction processing unit 42. The access instruction 202 is information for reporting a request described in the second line of the message 100 to the instruction processing unit 42. The access instruction 203 is information for reporting a request described in the third line of the message 100 to the instruction processing unit 42.

As an example, processing relating to the access instruction 201 is described. Processing of the access instruction 202 or 203 is similar to processing of the access instruction 201, however, the key, processing content, and parameter are different.

The event processing unit 41 reports the access instruction 201 that is generated in S101 to the instruction processing unit 42 (S102).

When the access instruction 201 is reported, the instruction processing unit 42 obtains the key A included in the access instruction 201 (S103). When data that corresponds to the key A is stored in the high-speed storage medium 50, the instruction processing unit 42 may read the data that corresponds to the key A from the high-speed storage medium 50, and may perform analytical processing for adding “parameter=10” to a parameter included in the read data. In the following description, it is assumed that data that corresponds to the key A is been stored in the high-speed storage medium 50.

Then, the instruction processing unit 42 reports the obtained key A to the segment managing unit 43 (S104).

When the key A is reported, the segment managing unit 43 refers to the segment management table 300, and obtains a segment ID (Identifier) that identifies a segment that corresponds to the key A (S105).

The segment managing unit 43 reports the obtained segment ID to the instruction processing unit 42 (S106). When a segment that corresponds to the reported segment ID is stored in the high-speed storage medium 50, the instruction processing unit 42 may determine that data that corresponds to the key A is stored in the high-speed storage medium 50. In this example, since it is assumed that the data that corresponds to the key A is not stored, the segment that corresponds to the segment ID is not stored in the high-speed storage medium 50.

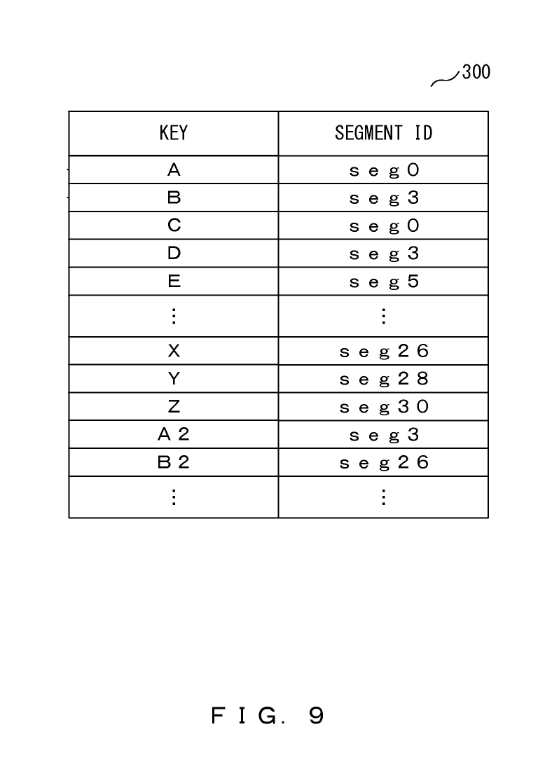

With reference to FIG. 9, the segment management table 300 is now described.

The segment management table 300 is a table in which keys and segment IDs are stored in association with each other, as illustrated in FIG. 9. In other words, the segment management table 300 indicates which segment data that corresponds to a key belongs to. Thus, in the example illustrated in FIG. 9, “segment ID=seg0” that corresponds to the key A is obtained in S105. The segment management table 300 of FIG. 9 indicates that respective pieces of data that correspond to the key A and the key C belong to the same segment that corresponds to seg0. The segment management table 300 may be configured such that pieces of data that are highly likely to continue to be accessed in analytical processing belong to the same segment. The segment management table 300 may be prepared in advance or may be updated by reflecting an access state in analytical processing. Updating by reflecting an access state in analytical processing is, for example, processing of retrieved data that is highly likely to continue to be accessed in analytical processing and configuring the retrieved data groups so as to belong to the same segment.

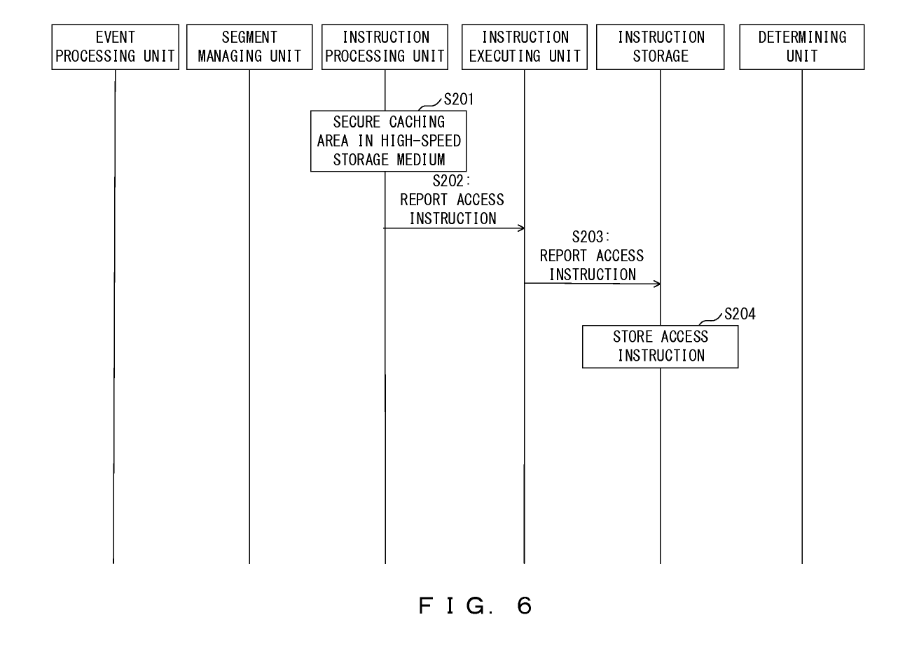

When the segment ID (for example, seg0) that the segment managing unit 43 has obtained in S105 is reported, as illustrated in FIG. 6, the instruction processing unit 42 secures a storage area having a specified size (capacity) in a storage area of the high-speed storage medium 50 (S201). In the following description, the storage area having a specified size is referred to as a “caching area”. The size of a caching area may be determined in advance, or may be changed in accordance with a processing state of stream data processing. As an example, the size of a caching area may be configured to be larger, as the high-speed storage medium 50 included in the server 30 has a larger capacity. As another example, the size of a caching area may be configured to be larger, as the server 30 has a higher analytical processing performance and performs processing at a higher speed.

The instruction processing unit 42 reports the access instruction 201 to the instruction executing unit 61 (S202). In this case, the instruction processing unit 42 may report a request to read a data group stored in a disk and a segment ID obtained by the segment managing unit 43 to the instruction executing unit 61, along with the access instruction 201. The following description is given under the assumption that the instruction processing unit 42 reports the access instruction 201, a request to read a data group stored in a disk, and a segment ID obtained by the segment managing unit 43 to the instruction executing unit 61. For a simple description, it is assumed that the access instruction 201 includes a request to read a data group and a segment ID. The access instruction 201 is not limited to this, and may be any request to cause the instruction executing unit 61 to read a segment used for analytical processing and report the read segment to the instruction processing unit 42.

When the access instruction 201 is reported, the instruction executing unit 61 reports the access instruction 201 to the instruction storage 62 (S203).

When the access instruction 201 is reported, the instruction storage 62 stores the reported access instruction 201 (S204). The instruction storage 62 is, for example, a queue, and buffers one or more access instructions 200 that are sequentially reported in data stream processing.

After stream data processing is performed and the instruction executing unit 61 reports the first access instruction 200 to the instruction storage 62, the instruction executing unit 61 requests another access instruction 200 from the instruction storage 62 (S301). The instruction executing unit 61 may request the next access instruction 200 from the instruction storage 62 every time the writing or reading of data to/from the low-speed storage medium 70 that the access instruction 200 requests is completed.

When a request for the access instruction 200 is received, the instruction storage 62 fetches, for example, an oldest access instruction from among the stored access instructions (S302). In the following description, a case where the instruction storage 62 fetches an access instruction 201 is described as an example.

The instruction storage 62 transmits the fetched access instruction 201 to the instruction executing unit 61 (S303).

Upon receiving the access instruction 201, the instruction executing unit 61 obtains, from the address management table 400, a logical block address that corresponds to a segment ID of a segment from which the access instruction 201 requests reading (S304). The logical block address may be specified with LBA or CHS. LBA stands for Logical Block Addressing, and is a scheme of allocating sequence numbers to all blocks of the low-speed storage medium 70 and specifying the blocks by using the sequence numbers. CHS stands for Cylinder Head Sector, and is a scheme of specifying a location of data by using three values. In the following description, the logical block address may also be referred to as a “logical address”.

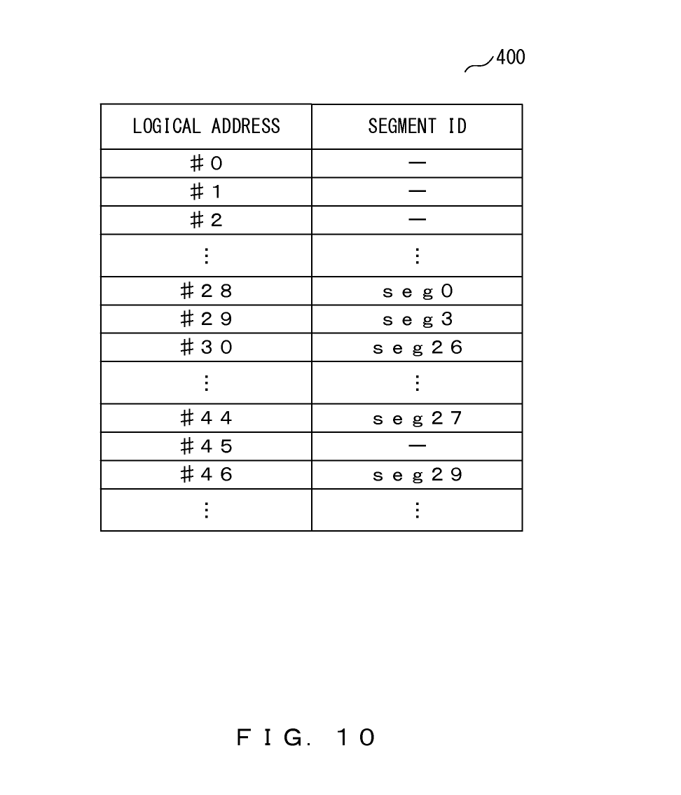

With reference to FIG. 10, the address management table 400 is now described. In FIG. 10, logical addresses are specified with LBA, and therefore areas having consecutive logical addresses are physically continuous.

As illustrated in FIG. 10, the address management table 400 is a table in which segment IDs and logical addresses have been stored in association with each other. In other words, the address management table 400 indicates which block in the low-speed storage medium 70 stores a segment that corresponds to a segment ID. The address management table 400 illustrated in FIG. 10 indicates as an example that segments that correspond to segment IDs seg0, seg3, and seg26 are respectively stored in blocks that correspond to logical addresses #28-#30. A block that corresponds to a logical address unspecified in the address management table 400 is an empty area in which a segment is not stored. The address management table 400 may be updated by the instruction executing unit 61 every time a segment is written to or read from the low-speed storage medium 70. This allows the address management table 400 to reflect a storage state of a segment in the low-speed storage medium 70 in real time.

The instruction executing unit 61 then requests that the determining unit 63 determine the number of segments to be read together in reading a segment that corresponds to a segment ID specified by the access instruction 201 (S305). The instruction executing unit 61 may make a request to determine the number of segments to be read together every time the instruction executing unit 61 performs processing of reading a segment that corresponds to a segment ID specified by the access instruction 201 (hereinafter also referred to as “reading processing”). In the description below, the number of segments to be read together may also be referred to as “the number of segments to be accessed”.

When a request to determine the number of segments is received, the determining unit 63 determines the number of segments to be accessed (S306).

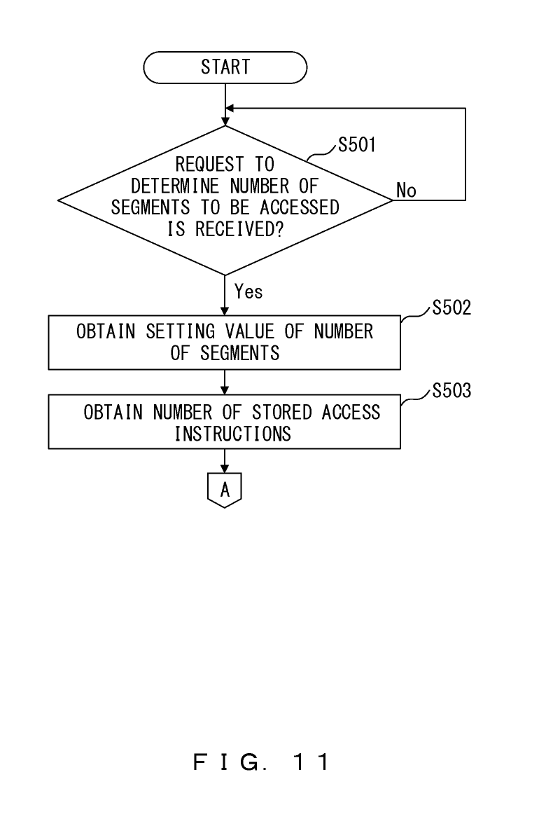

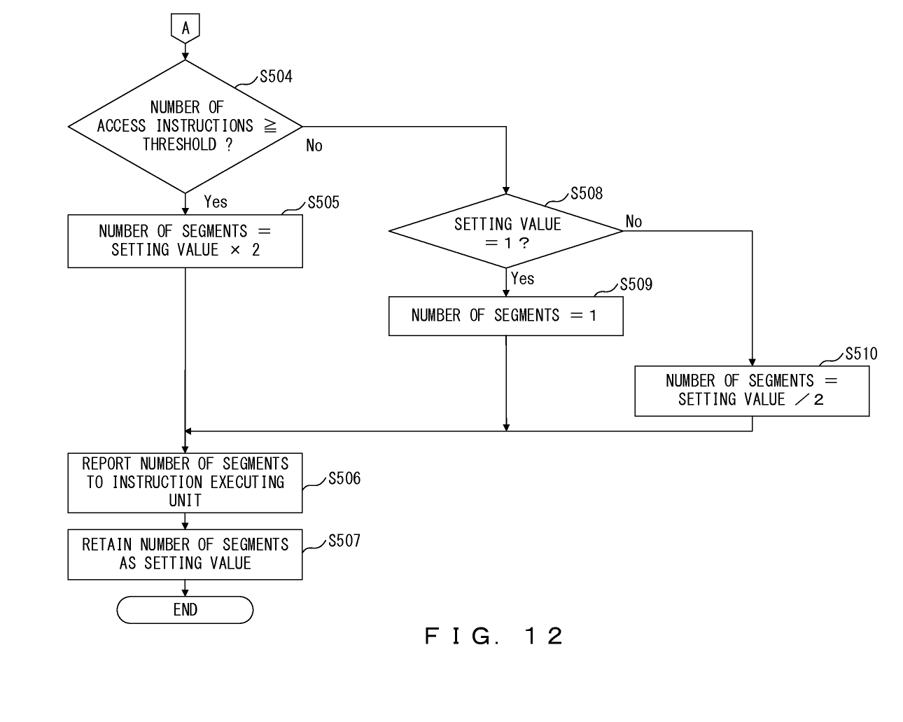

With reference to FIG. 11 and FIG. 12, processing in which the determining unit 63 determines the number of segments to be accessed is now described. FIG. 11 and FIG. 12 are flowcharts illustrating processing of determining the number of segments.

The determining unit 63 decides whether a request to determine the number of segments has been reported from the instruction executing unit 61. The determining unit 63 waits until a request to determine the number of segments is reported (No in S501).

When a request to determine the number of segments is reported (Yes in S501), the determining unit 63 obtains a setting value (S502). The setting value may be the number of segments that has been determined in the previous processing of determining the number of segments and that has been retained in the determining unit 63. Note that, an initial value of the setting value is not particularly limited, but may be one. The setting value may be stored in the low-speed storage medium 70 in the server 30 and may be used in access processing by loading to the high-speed storage medium 50 at the time of starting the storage middleware 60.

Further, the determining unit 63 obtains the number of access instructions 200 (a queue length) stored in the instruction storage 62 (S503). The stored number of access instructions 200 may be counted, for example, by a counter circuit that counts the number of access instructions 200 that are input to/output from the instruction storage 62. In this case, the determining unit 63 may obtain the number of access instructions 200 by reading a count value of the counter circuit. A method in which the determining unit 63 obtains the number of access instructions 200 is not particularly limited. As an example, when the instruction processing unit 42 and the instruction executing unit 61 communicate access instructions 200 with the credit method, the determining unit 63 may obtain the number of access instructions 200 stored in the instruction storage 62 based on the residual number of reception credits stored in the instruction executing unit 61.

The determining unit 63 determines whether the number of access instructions 200 stored in the instruction storage 62 is greater than or equal to a specified threshold (S504). The threshold indicates the number of access instructions 200 prepared in advance for the determining unit 63.

In S504, when the number of access instructions 200 stored in the instruction storage 62 is greater than or equal to the threshold (Yes in S504), the determining unit 63 doubles the setting value, and determines the doubled setting value so as to be the number of segments to be reported to the instruction executing unit 61 (S505). An increase in the number of access instructions 200 stored in the instruction storage 62 indicates that a frequency (number/second) at which an access instruction 200 is reported is greater than a frequency (number/second) at which an access instruction 200 is processed. In other words, an increase in the number of access instructions 200 stored in the instruction storage 62 indicates that an increasing number of access instructions 200 are stored in the instruction storage 62. Therefore, when the number of access instructions 200 is greater than or equal to the threshold, the determining unit 63 increases the number of segments to be read in one-time processing on the access instruction 200. As a result, the instruction executing unit 61 reads a plurality of segments in one-time processing on the access instruction 200, and suppresses the number of times of reading processing. This results in a decrease in the number of accesses to the low-speed storage medium 70 in access processing, and accordingly throughput in access processing is improved. The number of segments to be reported to the instruction executing unit 61 may increase, and an increase rate is not limited to 2 times.

Then, the determining unit 63 reports the number of segments determined in S505 to the instruction executing unit 61 (S506).

The determining unit 63 also retains the determined number of segments as a new setting value (S507). Then, the determining unit 63 terminates processing of determining the number of segments. As a result of retaining the determined number of segments as a new setting value, the determining unit 63 increases or decreases the number of segments by using the previous number of segments as a setting value in performing the next processing of determining the number of segments. Therefore, the determining unit 63 can adjust the number of segments such that the number of access instructions 200 stored in the instruction storage 62 does not continue to increase. In other words, the determining unit 63 adjusts the number of segments to be read in one-time reading processing such that a frequency at which an access instruction 200 is processed is not lower than a frequency at which an access instruction 200 is reported.

When the number of access instructions 200 stored in the instruction storage 62 is less than the threshold (No in S504), the determining unit 63 determines whether a setting value is 1 (S508).

When the setting value is 1, the determining unit 63 sets the number of segments to 1 (S509). The determining unit 63 then performs the processes of S506 and S507, and terminates processing of determining the number of segments.

When the setting value is not 1 (No in S508), the determining unit 63 sets the number of segments to be ½ times of the setting value (S510). The determining unit 63 then performs the processes of S506 and S507, and terminates processing of determining the number of segments. The number of segments to be reported to the instruction executing unit 61 may decrease, and a decrease rate is not limited to ½ times.

As described above, when the number of access instructions 200 stored in the instruction storage 62 is greater than or equal to a threshold, the determining unit 63 multiplies the number of segments to be read at a time by K (K>1). When the number of access instructions 200 stored in the instruction storage 62 is less than the threshold, the determining unit 63 multiplies the number of segments to be read at a time by L (L<1). Further, in obtaining the number of segments to be read at a time, the determining unit 63 calculates the number of segments based on n segments (n is a natural number) that have previously been read at a time (a setting value). As a result, the determining unit 63 can adjust the number of segments such that a frequency at which an access instruction 200 is processed is not less than a frequency at which an access instruction 200 is reported.

When the determining unit 63 determines the number of segments determined in S306, the determining unit 63 reports the number to the instruction executing unit 61 (S307).

When the number of segments to be read at a time is reported from the determining unit 63, the instruction executing unit 61 refers to the low-speed storage medium 70, and retrieves a block that corresponds to a logical address obtained in S304. The instruction executing unit 61 then reads segments of the number of segments reported in S307 from physically consecutive blocks including the block that corresponds to the logical address (S401). When the number of segments determined in S306 is 1, the instruction executing unit 61 reads a segment from the block that corresponds to the logical address obtained in S304.

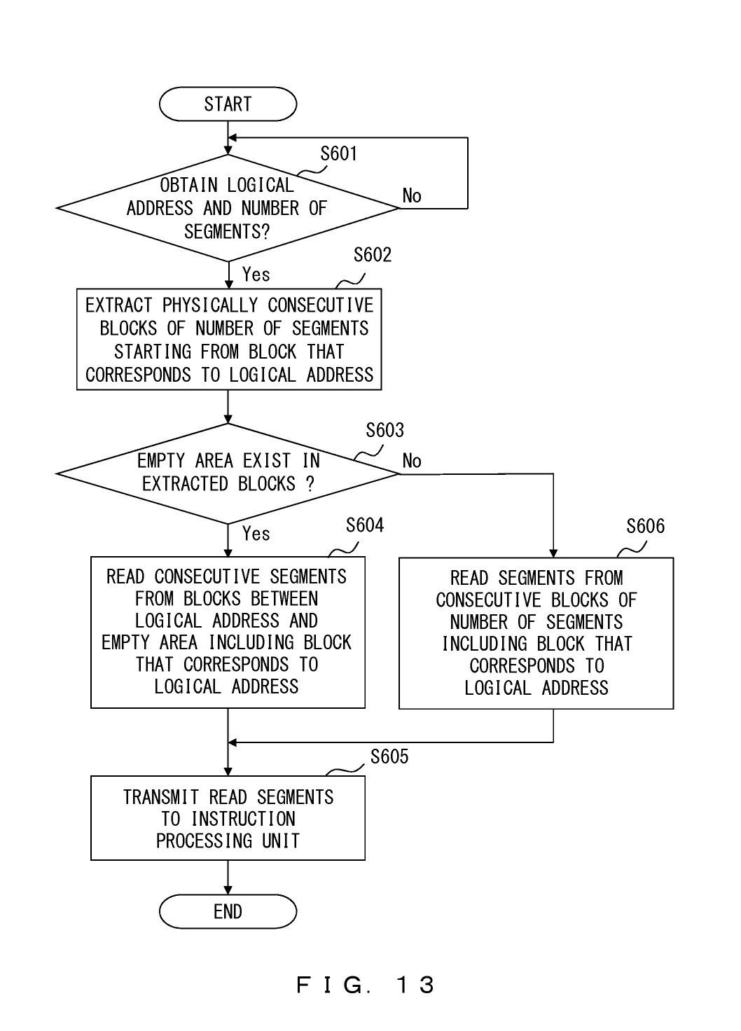

With reference to FIG. 13, processing in which the instruction executing unit 61 reads segments is now described.

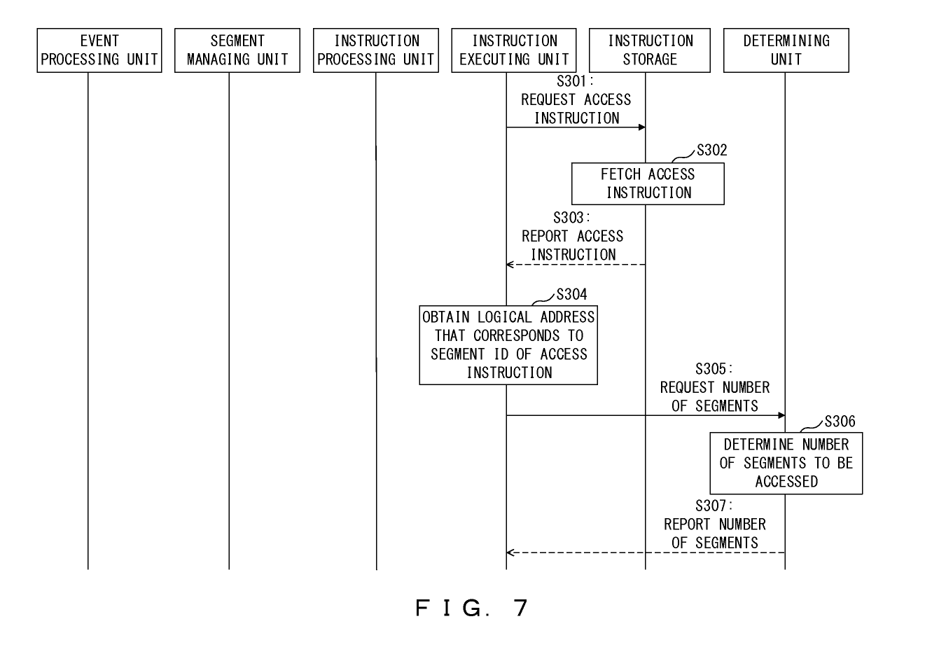

The instruction executing unit 61 decides whether a logical address and the number of segments to be read at a time have been obtained (S601). The instruction executing unit 61 waits until a logical address and the number of segments to be read at a time are reported (No in S601). The logical address is the logical address obtained in S304 of FIG. 7. In addition, the number of segments to be read at a time is the number of segments determined in S306 of FIG. 7. The description below is given under the assumption that the number of segments to be read at a time is n.

When a logical address and the number of segments to be read at a time are reported (Yes in S601), the instruction executing unit 61 refers to the low-speed storage medium 70, and retrieves a block that corresponds to the logical address. The instruction executing unit 61 then extracts n blocks that are physically consecutive including the retrieved block (S602). In this case, when logical addresses are allocated by using LBA, the n blocks that are physically consecutive are blocks having consecutive logical addresses. As an example, when an logical address #40 and “the number of segments=4” are reported to the instruction executing unit 61, the n blocks that are physically consecutive may be configured to be blocks #40-#43 by selecting the reported logical address #40 and logical addresses that follow the reported logical address #40. As another example, when a logical address #40 and “the number of segments=4” are reported to the instruction executing unit 61, the n blocks that are physically consecutive may be configured to be blocks #38-#41 including the reported logical address #40. Namely, the n blocks that are physically consecutive may be extracted with any appropriately selected method, if the n blocks are blocks that are physically consecutive in the low-speed storage medium 70, including the block that corresponds to the logical address reported to the instruction executing unit 61.

Then, the instruction executing unit 61 decides whether an empty area exists in the n extracted blocks (S603).

When the instruction executing unit 61 decides that an empty area exists in the n extracted blocks (Yes in S603), the instruction executing unit 61 reads one or more consecutive segments from blocks between the logical address and the empty area, including a block that corresponds to the logical address (S604).

The instruction executing unit 61 reports the one or more read segments to the instruction processing unit 42 (S605). Then, the instruction executing unit 61 terminates the processing of reading segments.

When the instruction executing unit 61 decides that an empty area does not exist in the n extracted blocks (No in S603), the instruction executing unit 61 reads segments from the n consecutive blocks including the block that corresponds to the logical address (S606). Then, the instruction executing unit 61 performs the process of S605, and terminates the processing of reading segments.

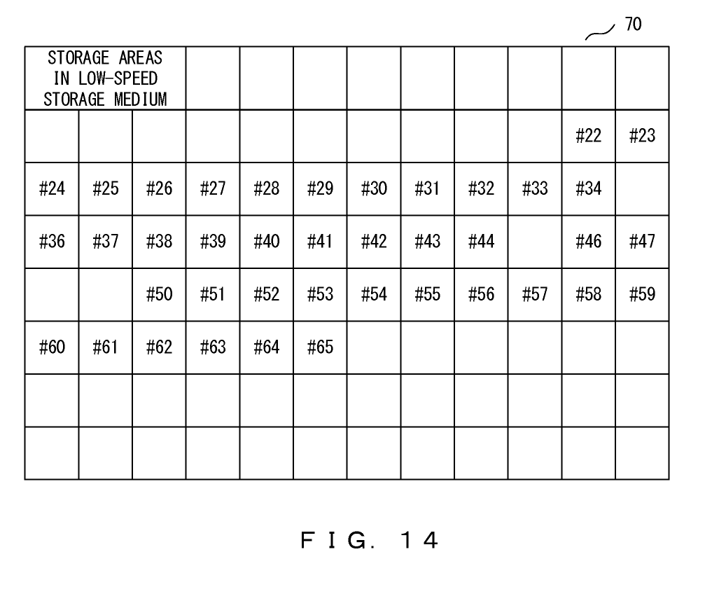

With reference to FIG. 14 to FIG. 16, the processing of reading segments is further described. In the description below, processing in which the instruction executing unit 61 selects blocks corresponding to a logical addresses and the reported number of segments, and reads segments respectively from the corresponding blocks is described as an example.

Rectangles in FIG. 14 to FIG. 16 respectively represents blocks in the low-speed storage medium 70. A block to which a number is allocated indicates that a segment is stored in the block. A block to which a number is not allocated indicates that a segment is not stored in the block. The number indicates a logical address of each of the blocks. In the example illustrated in FIG. 14, segments are stored in blocks #22-#34, #36-#44, #46, #47, and #50-#65 in the low-speed storage medium 70.

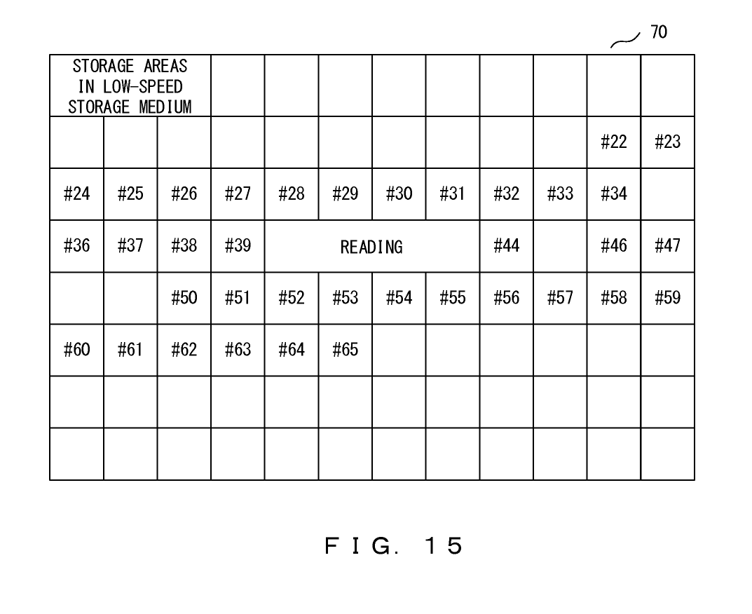

When “a logical address=#40” and “the number of segments=4” are reported, the instruction executing unit 61 reads segments from physically consecutive blocks #40-#43 starting from a block of “a logical address=“40”, as illustrated in FIG. 15. Namely, when “a logical address=#40” and “the number of segments=4” are reported to the instruction executing unit 61, a storage state of the low-speed storage medium 70 is changed from the state illustrated in FIG. 14 to the state illustrated in FIG. 15. In this case, the instruction executing unit 61 may read segments from physically consecutive blocks by referring to the address management table 400.

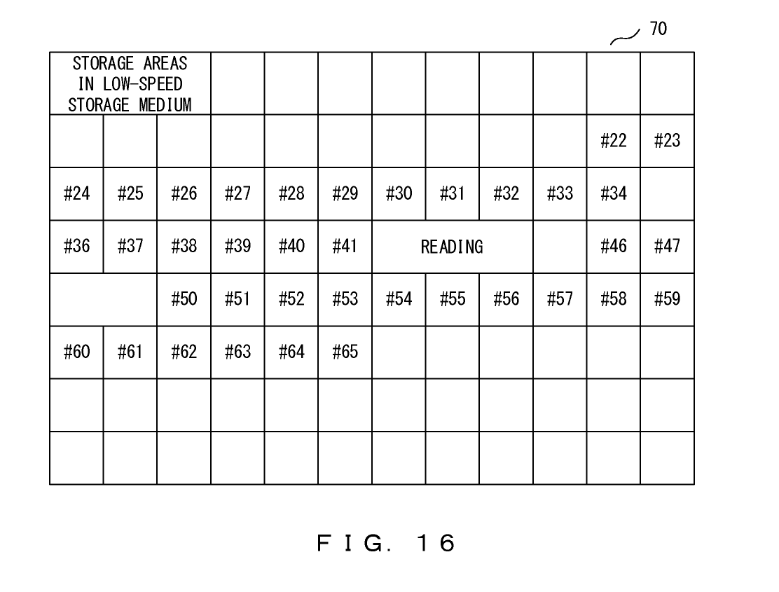

When “a logical address=#42” and “the number of segments=4” are reported in a storage state illustrated in FIG. 14, the instruction executing unit 61 reads segments from physically consecutive blocks #42-#44 starting from a block of “a logical address=#42”, as illustrated in FIG. 16. Namely, when “a logical address=#42” and “the number of segments=4” are reported to the instruction executing unit 61, a storage state of the low-speed storage medium 70 is changed from the state illustrated in FIG. 14 to the state illustrated in FIG. 16. Because “four” is specified as the number of segments to be read at a time but a block that corresponds to #45 in the low-speed storage medium 70 is an empty area, the instruction executing unit 61 does not read a segment from a block #46. This allows the instruction executing unit 61 to reduce the number of times of seeking process in reading processing, as an example, when the low-speed storage medium 70 is a disk. In this case, the instruction executing unit 61 may check the existence of an empty area by referring to the address management table 400, and may read segments from physically consecutive blocks.

When “a logical address=#42” and “the number of segments=4” are reported in a storage state illustrated in FIG. 14, the instruction executing unit 61 may read segments from physically consecutive blocks #40-#43 including a block of “a logical address=#42”, as illustrated in FIG. 15. In other words, when “a logical address=#42” and “the number of segments=4” are reported, the instruction executing unit 61 may change a storage state of the low-speed storage medium 70 from the state illustrated in FIG. 14 to the state illustrated in FIG. 15. As described above, the instruction executing unit 61 selects blocks that correspond to the reported number of segments, starting from a block having a reported logical address. When an empty area exists in the selected blocks, the instruction executing unit 61 may change blocks to be selected, and may read segments from physically consecutive blocks including a reference block. In this case, the instruction executing unit 61 may check the existence of a free are by referring to the address management table 400, and may read segments from physically consecutive blocks.

As described above, the instruction executing unit 61 can read one or more segments from physically consecutive blocks in which segments are stored, including a block that corresponds to a reported logical address, with any appropriately selected method.

In addition, when the instruction executing unit 61 reads segments in a storage requested by the access instruction 200, the instruction executing unit 61 reports, for example, an input/output instruction popitems_bulk(k,N) to an input/output controller (not illustrated) of the low-speed storage medium 70 (hereinafter referred to as a “disk controller”). k of popitems_bulk(k,N) represents a logical address of a block to be read that the instruction executing unit 61 obtains in S304, for example. N of popitems_bulk(k,N) represents the number of segments to be read at a time that, for example, the determining unit 63 determines. In addition, popitems_bulk(k,N) includes a request to delete read segments from blocks from which the segments have been read.

As an example, when the instruction executing unit 61 obtains “a logical address=#40” and “the number of segments to be read at a time=4”, the instruction executing unit 61 reports an input/output instruction popitems_bulk(#40, 4) to a disk controller. The disk controller reads segments from four blocks including a block that corresponds to “a logical address=#40” among physically consecutive blocks in which segments are stored, and transmits the read segments to the instruction executing unit 61. Then, the disk controller deletes the stored segments from the four blocks from which the segments have been read.

When the number of segments to be read at a time is 1, the instruction executing unit 61 may use an input/output instruction popitem(k). In this case, k of popitem(k) represents a logical address of a block to be read.

As an example, when the instruction executing unit 61 obtains “a logical address=#40” and “the number of segments=1”, the instruction executing unit 61 reports an input/output instruction popitem (#40) to the disk controller. The disk controller then reads a segment stored in a block that corresponds to “a logical address=#40”, and transmits the read segment to the instruction executing unit 61.

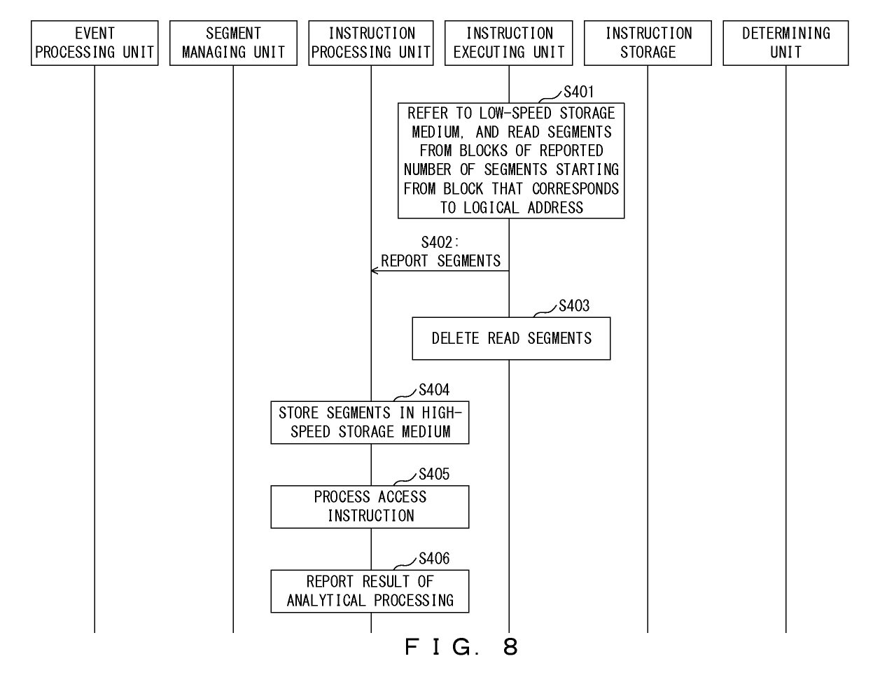

As illustrated in FIG. 8, the instruction executing unit 61 reports one or more segments read in S401 to the instruction processing unit 42 (S402). The instruction executing unit 61 then deletes the one or more segments read in S401 from the low-speed storage medium 70 (S403).

When the one or more segments are reported, the instruction processing unit 42 writes the reported one or more segments to the high-speed storage medium 50, and stores the reported one or more segments in the high-speed storage medium 50 (S404).

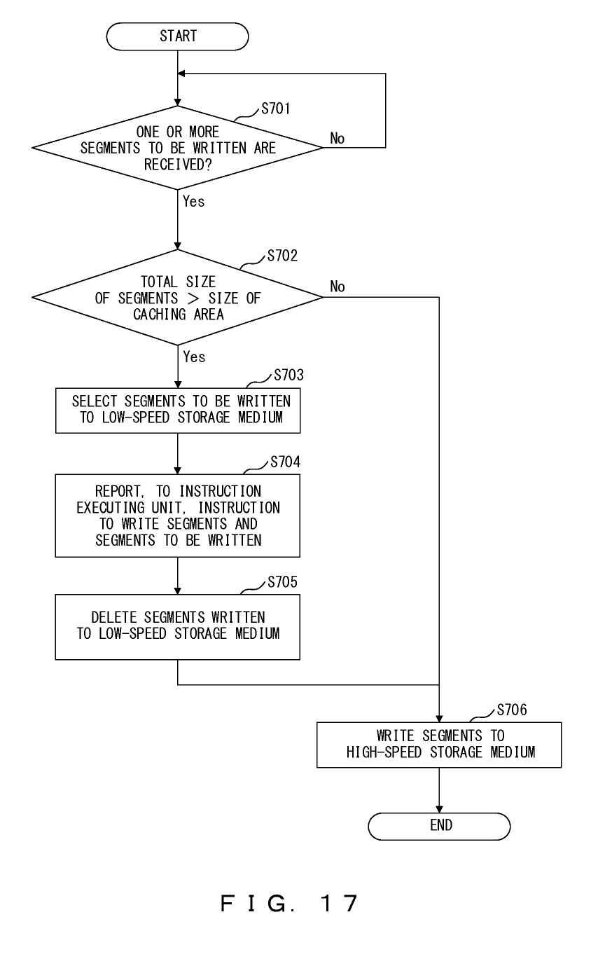

With reference to FIG. 17, processing in which the instruction processing unit 42 writes one or more segments to the high-speed storage medium 50 is now described.

The instruction processing unit 42 decides whether the instruction processing unit 42 has received the one or more segments that have been read by the instruction executing unit 61 in S401 of FIG. 8 (S701). Namely, the instruction processing unit 42 decides whether one or more segments to be written have been reported by the instruction executing unit 61. The instruction processing unit 42 waits until receipt of one or more segments to be written (No in S701).

Upon receipt of one or more segments to be written (Yes in S701), the instruction processing unit 42 decides whether a total size of the received one or more segments is larger than a size of a caching area secured in S201 of FIG. 6 (S702).

When the total size of the one or more segments received in S701 is larger than a size of the caching area secured in S201 of FIG. 6 (Yes in S702), the instruction processing unit 42 performs processing of writing segments stored in the high-speed storage medium 50 back to the low-speed storage medium 70.

The instruction processing unit 42 selects segments to be written to the low-speed storage medium 70 (S703). In this case, the instruction processing unit 42 selects one or more segments such that the sum of the total size of the selected segments and a size of the caching area is greater than or equal to the total size of the segments to be written to the high-speed storage medium 50, which have been received in S701.

In S703, the instruction processing unit 42 may select a least-needed segment from among segments stored in the low-speed storage medium 70. As the least-needed segment, a segment that has least recently been used in analytical processing may be selected by using, for example, LRU (Least Recently Used). The least-needed segment may be selected by using another algorithm that is not limited to LRU, such as LFU (Least Frequently Used). LFU indicates a frequency of use of each of the segments. When LFU is used, a least frequently used segment may be used for a least-needed segment. In addition, when the instruction processing unit 42 writes a plurality of segments stored in the high-speed storage medium 50 to the low-speed storage medium 70, the instruction processing unit 42 may select a plurality of segments to be written to the low-speed storage medium 70 in order from a least-needed segment.

When one or more segments to be written to the low-speed storage medium 70 are selected in S703, the instruction processing unit 42 reports, for example, an access instruction to write segments to the low-speed storage medium 70 and the selected one or more segments to the instruction executing unit (S704). The access instruction to write segments may also be referred to as a “writing instruction”.

The instruction processing unit 42 deletes the one or more segments that have been written to the low-speed storage medium 70 in S704 from a storage area in the high-speed storage medium 50 (S705). Namely, when a total size of one or more segments to be written to the high-speed storage medium 50 is larger than a secured caching area, the instruction processing unit 42 writes one or more segments back to the low-speed storage medium 70. This allows the instruction processing unit 42 to secure a caching area of a size that is larger than or equal to the total size of the one or more segments to be written to the high-speed storage medium 50.

Then, the instruction processing unit 42 performs processing of writing the one or more segments received in S701 to the caching area in the high-speed storage medium 50 that has been enlarged in S705 (S706). Then, the instruction processing unit 42 terminates processing of writing one or more segments to the high-speed storage medium 50.

When a total size of the one or more segments received in S701 is smaller than a size of the caching area secured in S201 of FIG. 6 (No in S702), the instruction processing unit 42 performs the process of S706. Then, the instruction processing unit 42 terminates processing of writing one or more segments to the high-speed storage medium 50.

As described above, the instruction processing unit 42 performs processing of writing one or more segments reported by the instruction executing unit 61 to the high-speed storage medium 50.

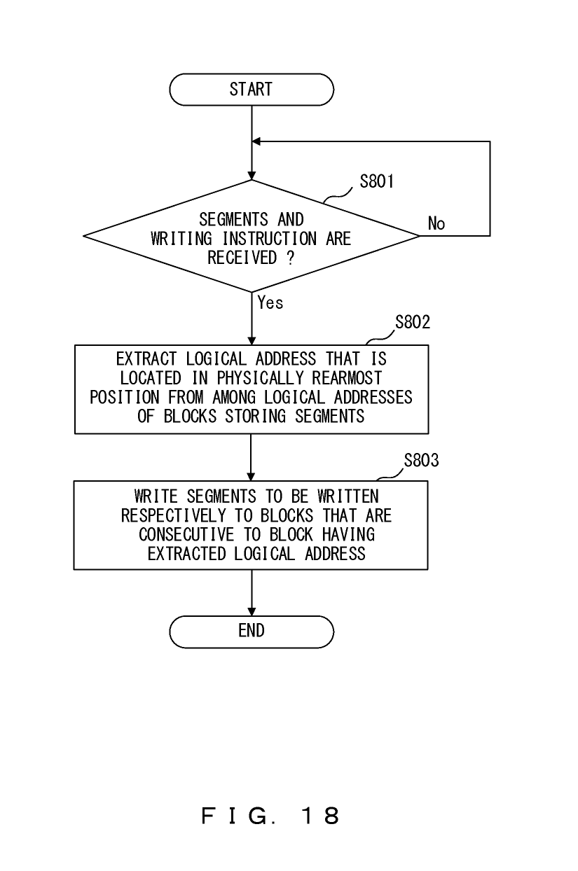

With reference to FIG. 18, processing of writing segments to the low-speed storage medium 70 that the instruction executing unit 61 performs upon receipt of an writing instruction that has been reported from the instruction processing unit 42 to the instruction executing unit 61 in S704 of FIG. 17 is now described.

The instruction executing unit 61 decides whether the process of S704 of FIG. 17 has been performed and one or more segments and a writing instruction have been received from the instruction processing unit 42 (S801). The instruction executing unit 61 waits until receipt of one or more segments and a writing instruction (No in S801).

Upon receipt of one or more segments and a writing instruction, the instruction executing unit 61 extracts a logical address that is located in the physically rearmost position from among logical addresses of blocks in which segments are stored in the low-speed storage medium 70 (S802). The instruction executing unit 61 may refer to the address management table 400 illustrated in FIG. 10, for example, and may retrieve a logical address that is located in the rearmost position among logical addresses associated with segment IDs and extract the retrieved logical address as a logical address that is located in the physically rearmost position. Then, the instruction executing unit 61 writes one or more segments to be written to physically consecutive blocks to the rear of a block that corresponds to the logical address extracted in S802 (S803).

As described above, when the instruction executing unit 61 writes one or more segments to the low-speed storage medium 70, the instruction executing unit 61 refers to the address management table 400, and writes the one or more segments to blocks that are physically consecutive from a block that is located at the physically rearmost position.

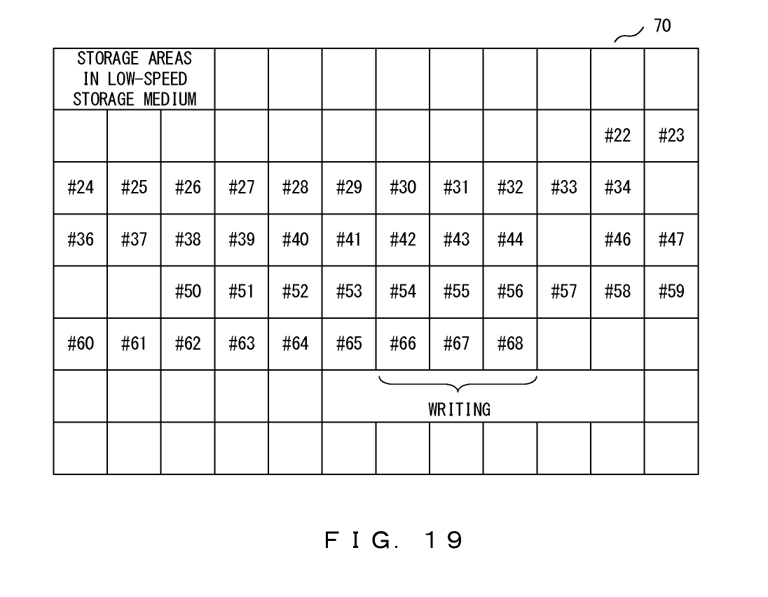

With reference to FIG. 19, the processing of writing segments to the low-speed storage medium 70 is further described.

FIG. 19 illustrates an example of a storage state of segments in a low-speed storage medium. The description below is given under the assumption that segments have been stored in #22-#34, #36-#44, #46, #47, and #50-#65, as illustrated in FIG. 14, in a writing area of the low-speed storage medium 70 before writing processing. FIG. 19 illustrates segments stored in blocks in the low-speed storage medium 70 after writing three segments reported by the instruction processing unit 42.

When three segments and a writing instruction are reported from the instruction processing unit 42, the instruction executing unit 61 extracts a block that corresponds to the rearmost logical address from among blocks in which segments have been stored. Namely, the instruction executing unit 61 extracts a storage area that is located at the physically rearmost position from among storage areas to which one or more segments have been written. In this case, the instruction executing unit 61 may refer to the address management table 400 and extract a block that is located at the physically rearmost position. As an example, when three segments and a writing instruction are reported, the instruction executing unit 61 extracts a block of “a logical address=#65”, which is located in the physically rearmost position, in a case in which the low-speed storage medium 70 has the storage state illustrated in FIG. 14.

Then, the instruction executing unit 61 writes the one or more segments reported from the instruction processing unit 42 to blocks that are physically consecutive to a block that corresponds to the rearmost logical address. As an example, when three segments and a writing instruction are reported, the instruction executing unit 61 writes the segments to blocks of #66-#68, as illustrated in FIG. 19. Namely, when three segments and a writing instruction are reported, the instruction executing unit 61 changes a storage state of the low-speed storage medium 70 from the state illustrated in FIG. 14 to the state illustrated in FIG. 19.

When no segments have been written in the low-speed storage medium 70, the instruction executing unit 61 may write one or more segments that have been reported respectively to blocks that are physically consecutive, for example, to a block that corresponds to a preset logical address.

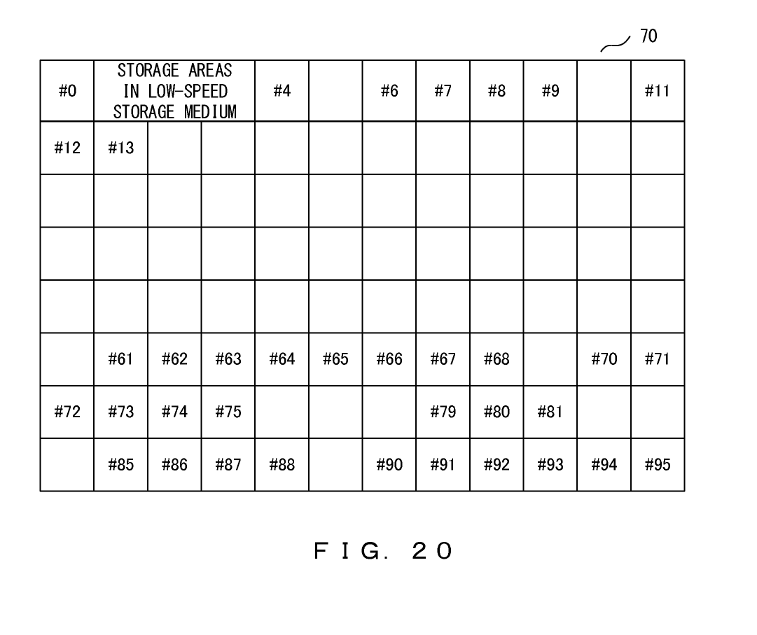

FIG. 20 illustrates an example of a storage state of segments in a low-speed storage medium. When a segment is stored in a block that corresponds to the rearmost logical address #95 in the low-speed storage medium 70, as illustrated in FIG. 20, the instruction executing unit 61 may judge that the first logical address #0 is a logical address that follows the rearmost logical address #95. When the low-speed storage medium 70 has the state illustrated in FIG. 20, the instruction executing unit 61 extracts a block of #13 as a block that corresponds to the rearmost logical address among blocks in which segments are stored. Then, the instruction executing unit 61 writes one or more segments reported from the instruction processing unit 42, to blocks that are physically consecutive to the block of #13.

When the instruction processing unit 42 writes one or more segments to the low-speed storage medium 70, the instruction processing unit 42 uses, for example, an input/output instruction pushitems_bulk ([k1,v1], [k2,v2], . . . , [kN,vN]). k1 to kN of pushitems_bulk([k1,1], [k2,v2], . . . , [kN,vN]) respectively represent segment IDs. v1 to vN of pushitems_bulk([k1,v1], [k2,v2], . . . , [kN,vN]) respectively represent segments.

As an example, when the instruction processing unit 42 writes one or more segments to the low-speed storage medium 70, the instruction processing unit 42 obtains logical addresses that correspond to k1-kN, which are IDs of the one or more segments to be written, from the address management table 400. The instruction processing unit 42 also reads, for example, segments v1-vN that correspond to the segment IDs k1-kN from the high-speed storage medium 50. Then, the instruction processing unit 42 reports pushitems_bulk([k1,v1], [k2,v2], . . . , [kN,vN]) to the instruction executing unit 61.

When pushitems_bulk([k1,v1], [k2,v2], . . . , [kN,vN]) is reported, the instruction executing unit 61 refers to the address management table 400, and extracts a block that is located in the physically rearmost position. Then, the instruction executing unit 61 reports pushitems_bulk([k1,v1], [k2,v2], . . . , [kN,vN]) and a logical address of the block that is located in the physically rearmost position to the disk controller. As a result, the instruction executing unit 61 makes the disk controller write one or more segments respectively to empty areas that are physically continuous to the block located in the physically rearmost position in the low-speed storage medium 70 and in which no segments have been stored.

When the instruction processing unit 42 stores the one or more segments reported in S402 in the high-speed storage medium 50 in S404, as illustrated in FIG. 8, the instruction processing unit 42 executes the access instruction 201 by using segments stored in the high-speed storage medium 50 (S405).

Then, the instruction processing unit 42 reports an analysis result obtained as a result of the process of the access instruction 201 to the client 10 via the event processing unit 41 and the network 20 (S406). As an example, when the instruction processing unit 42 obtains an analysis result according to a plurality of access instructions 200 (such as access instructions 201-203), the instruction processing unit 42 may temporarily store a processing result of the access instruction 201 in the high-speed storage medium 50. When the instruction processing unit 42 completes all of the processes of the access instructions 200, the instruction processing unit 42 may report an analysis result to the client 10.

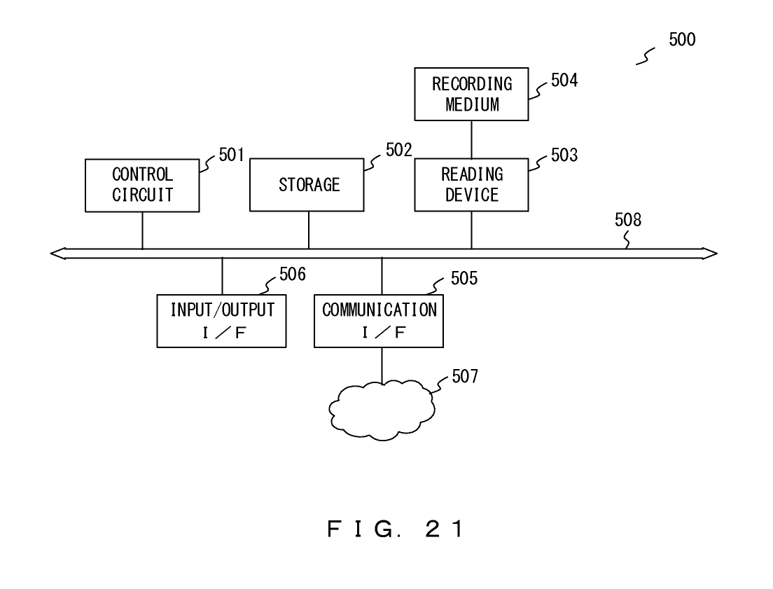

FIG. 21 is a block diagram illustrating an example of a computer device. The client 10 and the server 30 may respectively be implemented by a computer device illustrated in FIG. 21. Thus, with reference to FIG. 21, configurations of the client 10 and the server 30 are described.

In FIG. 21, a computer device includes a control circuit 501, a storage 502, a reading device 503, a recording medium 504, a communication interface (communication I/F) 505, and an input/output interface (input/output I/F) 506. The computer device 500 can be connected to a network 507 via the communication interface 505. The respective components are connected via a bus 508.

The control circuit 501 controls the computer device 500. Examples of the control circuit 501 include a CPU, a multicore CPU, an FPGA (Field Programmable Gate Array), and a PLD (Programmable Logic Device).

When the computer device 500 is the server 30, the control circuit 501 functions, for example, as the event processing unit 41, the instruction processing unit 42, and the segment managing unit 43 of FIG. 4. Further, when the computer device 500 is the server 30, the control circuit 501 functions, for example, as the instruction executing unit 61, the instruction storage 62, and the determining unit 63 of FIG. 4. The segment management table 300 and the address management table 400 may be stored, for example, in a cache of a CPU, an FPGA, or a PLD.

The storage 502 stores various pieces of data. The storage 502 is configured, for example, of a memory such as a ROM (Read Only Memory) or a RAM (Random Access Memory), an HD (Hard Disk), or the like.

When the computer device 500 is the server 30, the storage 502 functions, for example, as the high-speed storage medium 50 (such as a memory) and the low-speed storage medium 70 (such as an HD) of FIG. 4.

The ROM stores a program such as a boot program. The RAM is used as a work area of the control circuit 501. The HD stores a program such as an OS, an application program, or firmware, and various pieces of data.

When the computer device 500 is the server 30, the storage 502 stores, for example, the scheduler 40 that causes the control circuit 501 to function as the event processing unit 41, the instruction processing unit 42, and the segment managing unit 43. In addition, when the computer device 500 is the server 30, the storage 502 stores, for example, the storage middleware 60 that causes the control circuit 501 to function as the instruction executing unit 61, the instruction storage 62, and the determining unit 63. The segment management table 300 may be included in the scheduler 40, or may be stored in the storage 502 in association with the scheduler 40. When the segment management table 300 is stored in the storage 502 in association with the scheduler 40, the segment management table 300 may be used in access processing by being loaded to the RAM at the time of starting the scheduler 40. The address management table 400 may be included in the storage middleware 60, or may be stored in the storage 502 in association with the storage middleware 60. When the address management table 400 is stored in the storage 502 in association with the storage middleware 60, the address management table 400 may be used in access processing by being loaded to the RAM at the time of starting the storage middleware 60.

When access control is performed, the server 30 loads the scheduler 40 and the storage middleware 60 that have been stored in the storage 502 to the RAM. As a result, the server 30 performs access control processing by causing the control circuit 501 to execute the scheduler 40 and the storage middleware 60 loaded to the RAM. Note that the scheduler 40 and the storage middleware 60 may be stored in a storage device on the network 507 if the control circuit 501 is accessible via the communication interface 505.

The reading device 503 is controlled by the control circuit 501 so as to read/write data in the removable recording medium 504. Examples of the reading device 503 include an FDD (Floppy Disk Drive), a CDD (Compact Disc Drive), a DVDD (Digital Versatile Disk Drive), a BDD (Blu-ray Disk Drive: registered trademark), and a USB (Universal Serial Bus). The reading device 503 may read and store the scheduler 40 or the storage middleware 60 stored in the detachable recording medium 504 in the storage 502.

The recording medium 504 stores various pieces of data. When the computer device 500 is the server 30, the recording medium 504 stores, for example, the scheduler 40 and the storage middleware 60. Further, the recording medium 504 may store the segment management table 300 and the address management table 400. The recording medium 504 is connected to the bus 508 via the reading device 503, and the control circuit 501 controls the reading device 503 so as to read/write data from/to the recording medium 504. Examples of the recording medium 504 include a FD (Floppy Disk), a CD (Compact Disc), a DVD (Digital Versatile Disk), a BD (Blu-ray Disk: registered trademark), and a flash memory.

The communication interface 505 communicably connects the computer device and other devices via the network 507. When the computer device 500 is the server 30, the communication interface 505 is used to communicate information with the client 10.

The input/output interface 506 is connected, for example, to a keyboard, a mouse, a touch panel, and the like, and when signals indicating various pieces of information are input from connected devices, the input/output interface 506 outputs the input signals to the control circuit 501 via the bus 508. When signals that have been output from the control circuit 501 and that indicate various pieces of information are input via the bus 508, the input/output interface 506 outputs the signals to respective connected devices.

Examples of the network 507 include a LAN, wireless communication network, and the internet, and the network 507 communicatively connects the computer device 500 and other devices. The network 507 is, for example, the network 20 of FIG. 2.

As described above, when reading segments from the low-speed storage medium 70, the storage middleware 60 according to the embodiment causes the server 30 to perform process of reading one or more segments including a segment specified by a reading instruction at a time. This allows the storage middleware 60 to reduce the number of times of reading of segments from the low-speed storage medium 70 and to improve throughput in access processing.

In addition, when reading one or more segments at a time, the storage middleware 60 according to the embodiment causes the server 30 to perform process of reading segments from physically consecutive blocks in the low-speed storage medium 70. This allows the storage middleware 60 to reduce the number of times of seeking process at the time of reading data from the low-speed storage medium 70 and to improve throughput in access processing.

When writing segments to the low-speed storage medium 70, the storage middleware 60 according to the embodiment causes the server 30 to perform process of referring to the address management table 400. The storage middleware 60 according to the embodiment causes the server 30 to perform process of writing one or more segments to blocks that are physically consecutive to a block that is located in the physically rearmost position. This allows the storage middleware 60 to eliminate the determination of whether one or more segments to be written are additional segments or updating segments at the time of writing segments to the low-speed storage medium 70. Therefore, the storage middleware 60 can improve throughput in access processing.

By consecutively writing one or more segments to physically consecutive blocks, as described above, the storage middleware 60 can eliminate random access at the time of writing segments to the low-speed storage medium 70. This allows the storage middleware 60 to reduce the number of times of seeking process in access processing and to improve throughput in the access processing.

When reading segments from the low-speed storage medium 70, the storage middleware 60 according to the embodiment causes the server 30 to perform process of deleting the read segments. This allows the storage middleware 60 to set all of the segments to be written to be additional segments in writing processing. Therefore, the server 30 does not need to determine whether segments to be written are additional segments or updating segments in the writing process. Accordingly, the storage middleware 60 does not need management information that manages the existence of segments. Namely, the storage middleware 60 does not use management information including a large amount of data in access processing, and therefore memory consumption can be suppressed.

One or more embodiments of the present invention are not limited to the embodiment described above, and various configurations and embodiments can be employed without departing from the scope of the one or more embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an access control program that causes a computer to execute a process comprising:
in response to a first access instruction that instructs accessing first data, reading the first data and second data from a storage and deleting the first data and the second data from the storage, the first data being read from a first storage area, the second data being read from a second storage area that is physically adjacent to the first storage area and is not an empty area; and
in response to a second access instruction that instructs writing third data to the storage, writing the third data to a third storage area that is adjacent to a storage area located in a physically rearmost position among storage areas in which data has been stored in the storage.

2. A non-transitory computer-readable recording medium having stored therein an access control program that causes a computer to execute a process comprising:
in response to a first access instruction that instructs accessing a first data group including one or more pieces of data stored in a storage, reading n data groups that respectively include one or more pieces of data from physically continuous n storage areas and deleting the n data groups from the storage, the n storage areas including a first storage area in which the first data group is stored, n being a natural number; and
in response to a second access instruction that instructs writing, to the storage, the m data groups that respectively include one or more pieces of data, specifying a storage area located at an edge of storage areas in which data groups are respectively stored and writing the m data groups to continuous m storage areas located adjacent to the specified storage area, m being a natural number.

3. The non-transitory computer-readable recording medium according to claim 2, wherein
when an empty area exists in the n storage areas, L data groups are read from physically continuous L storage areas in which data groups are respectively stored, the L storage areas belongs to the n storage areas and includes the first storage area, L is a natural number and smaller than n,
the L data groups are deleted from the storage.

4. The non-transitory computer-readable recording medium according to claim 2, wherein
when a plurality of access instructions are received, the plurality of access instructions are stored in an instruction storage,
when a number of the stored access instructions increases, a number of data groups to be read at a time increases,
when the number of the stored access instructions decreases, the number of data groups to be read decreases.

5. The non-transitory computer-readable recording medium according to claim 4, wherein
when the number of the stored access instructions is greater than or equal to a specified threshold, the number of data groups to be read is multiplied by K (K>1), and when the number of the stored access instructions is less than the specified threshold, the number of data groups to be read is multiplied by L (L<1).

6. The non-transitory computer-readable recording medium according to claim 4, wherein
the process of increasing or decreasing the number of data groups to be read is performed every time the reading of the data groups is performed.

7. A disk drive comprising:
a disk that stores information; and
a processor that performs:
in response to a first access instruction that instructs accessing first data, reading the first data and second data from the disk and deleting the first data and the second data from the disk, the first data being read from a first storage area, the second data being read from a second storage area that is physically adjacent to the first storage area and is not an empty area; and
in response to a second access instruction that instructs writing third data to the disk, writing the third data to a third storage area that is adjacent to a storage area located in a physically rearmost position among storage areas in which data has been stored in the disk.

8. An access control method performed by a computer, the access control method comprising:
in response to a first access instruction that instructs accessing first data, reading the first data and second data from a storage and deleting the first data and the second data from the storage, the first data being read from a first storage area, the second data being read from a second storage area that is physically adjacent to the first storage area and is not an empty area; and
in response to a second access instruction that instructs writing third data to the storage, writing the third data to a third storage area that is adjacent to a storage area located in a physically rearmost position among storage areas in which data has been stored in the storage.
